(19) United States
(12) Patent Application Publication
(10) Pub. No.: US 2014/0310212 A1
(43) Pub. Date: Oct. 16, 2014

(54) METHOD AND DEVICE FOR CREATING A NONPARAMETRIC, DATA-BASED FUNCTION MODEL

(71) Applicants: The Duy NGUYEN-TUONG, Leonberg (DE); Heiner MARKERT, Stuttgart (DE); Volker IMHOF, Kornwestheim (DE); Ernst KLOPPENBURG, Ditzingen (DE); Felix STREICHERT, 1-3-4 Edakita (JP); Michael HANSELMANN, Korntal (DE)

(72) Inventors: The Duy NGUYEN-TUONG, Leonberg (DE); Heiner MARKERT, Stuttgart (DE); Volker IMHOF, Kornwestheim (DE); Ernst KLOPPENBURG, Ditzingen (DE); Felix STREICHERT, 1-3-4 Edakita (JP); Michael HANSELMANN, Korntal (DE)

(73) Assignee: Robert Bosch GmbH, Stuttgart (DE)

(21) Appl. No.: 14/247,623

(22) Filed: Apr. 8, 2014

(30) Foreign Application Priority Data
Apr. 10, 2013 (DE) 10 2013 206 285.0

(51) Int. Cl. G06F 17/50; G06N 99/00

(52) U.S. Cl. CPC G06F 17/5009; G06N 99/005
USPC 706/12

(57) ABSTRACT

A method for ascertaining a nonparametric, data-based function model, in particular a Gaussian process model, using provided training data, the training data including a number of measuring points which are defined by one or multiple input variables and which each have assigned output values of at least one output variable, including: selecting one or multiple of the measuring points as certain measuring points or adding one or multiple additional measuring points to the training data as certain measuring points; assigning a measuring uncertainty value of essentially zero to the certain measuring points; and ascertaining the nonparametric, data-based function model according to an algorithm which is dependent on the certain measuring points of the modified training data and the measuring uncertainty values assigned in each case.

### RELATED APPLICATION INFORMATION

The present application claims priority to and the benefit of German patent application No. 10 2013 206 285.0, which was filed in Germany on Apr. 10, 2013, the disclosure of which is incorporated herein by reference.

### FIELD OF THE INVENTION

The present invention relates to methods for creating nonparametric, data-based function models, in particular based on Gaussian processes.

### BACKGROUND INFORMATION

Control unit functions which the control unit requires to carry out its specific control functions are usually implemented in control units of motor vehicles. The control unit functions are usually based on the control path and system models which allow the system behavior to be modeled, in particular the behavior of an internal combustion engine to be controlled in the case of an engine control unit.

Such function models are frequently described based on characteristic curves or characteristic maps, which are adapted to the control unit function to be modeled using complex application methods. Due to the high application complexity for adapting the function models, the entire development complexity is very high. In addition, complex processes such as combustion processes in an internal combustion engine allow merely an approximate creation of the physical function model, which in some circumstances is not sufficiently precise for the control unit functions to be implemented.

It is discussed in the publication DE 10 2010 028 266 A1, for example, to implement the function model in the form of a nonparametric, data-based model. The calculation of the output variable is carried out using a Bayesian regression method. In particular, it is provided to implement the Bayesian regression as a Gaussian process or as a sparse Gaussian process.

### SUMMARY OF THE INVENTION

According to the present invention, a method for creating a nonparametric, data-based function model with the aid of node data as described herein and the device and the computer program as recited in the further descriptions herein are provided.

Further advantageous embodiments are specified herein.

According to a first aspect, a method for ascertaining a nonparametric, data-based function model from provided training data is provided, the training data including a number of measuring points which are defined by one or multiple input variables and which each have assigned output values of an output variable. The method includes the following steps:
selecting one or multiple of the measuring points as certain measuring points or adding one or multiple additional measuring points to the training data as certain measuring points;
assigning a measuring uncertainty value of essentially zero to the certain measuring points; and
ascertaining the nonparametric, data-based function model according to an algorithm which is dependent on the certain measuring points of the training data and the measuring uncertainty values assigned in each case.

The creation of nonparametric, data-based function models usually takes place under the model assumption that the measuring uncertainty or the measuring noise is identical for all measuring points of the training data. This means that the concrete measuring error for each measuring point arises from the normally distributed random variable having a standard deviation which applies equally to each measuring point. A function model created in this way results in a model function whose function values at the measuring points may deviate accordingly from the output values of the training data at the measuring points.

When function models are used for functions in an engine control unit for an internal combustion engine, it may be necessary to exactly or almost exactly predefine the value of the function model at one or multiple measuring points. This means that either existing measuring points of the training data may be provided with the property that the function model to be modeled passes exactly, or with only very minor deviation, through the measuring point or measuring points in question, or further artificial measuring points may be added, no or only a very small measuring uncertainty having to be considered for the added measuring points in the creation of the data-based function model so that the function curve of the function model passes exactly or almost exactly through the corresponding measuring points.

It is therefore provided to individually adapt the measuring uncertainty of the particular measuring points of the training data or of the additional measuring points using measuring uncertainty values. To achieve that, the function curve of the created function model passes exactly, or with only very minor deviation, through the particular output variables of the corresponding measuring points; a measuring uncertainty value of zero or approximately zero is applied to the measuring points in question, while a higher measuring uncertainty value is applied to the remaining measuring points.

Moreover, measuring uncertainty values having the level of a variance of the provided training data may be assigned to the measuring points which do not form part of the certain measuring points.

According to one specific embodiment, the nonparametric, data-based function model may be defined with the aid of a covariance matrix, a diagonal matrix being applied to the covariance matrix, the diagonal matrix values of which are assigned to the certain measuring points of the training data having a value of zero or approximately zero.

In particular, the nonparametric, data-based function model may be ascertained as a Gaussian process model or as a sparse Gaussian process model.

According to one further aspect, a device, in particular an arithmetic unit, for ascertaining a nonparametric, data-based function model using provided training data is provided, the training data including a number of measuring points which are defined by one or multiple input variables and which each have assigned output values of an output variable. The device is configured to:
select one or multiple of the measuring points as certain measuring points or add one or multiple additional measuring points to the training data as certain measuring points;
assign a measuring uncertainty value of zero or approximately zero to the certain measuring points; and
ascertain the nonparametric, data-based function model according to an algorithm which is dependent on the certain measuring points of the training data and the measuring uncertainty values assigned in each case.

According to one further aspect, a computer program is provided which is configured to carry out all steps of the above-described method.

Specific embodiments of the present invention are described in greater detail hereafter based on the accompanying drawings.

### BRIEF DESCRIPTION OF THE DRAWINGS

FIG. 1 shows a flow chart to illustrate the method for ascertaining a function model using measuring points of training data for which no measuring uncertainty is allowed.

FIG. 2 shows a curve of the function values of a function model before and after measuring points are added for whose assigned output value in each case the function model is to be an exact fit.

FIG. 3 shows a curve of the function values of a function model before and after measuring points are added for whose assigned output value in each case the function model is to be an exact fit.

### DETAILED DESCRIPTION

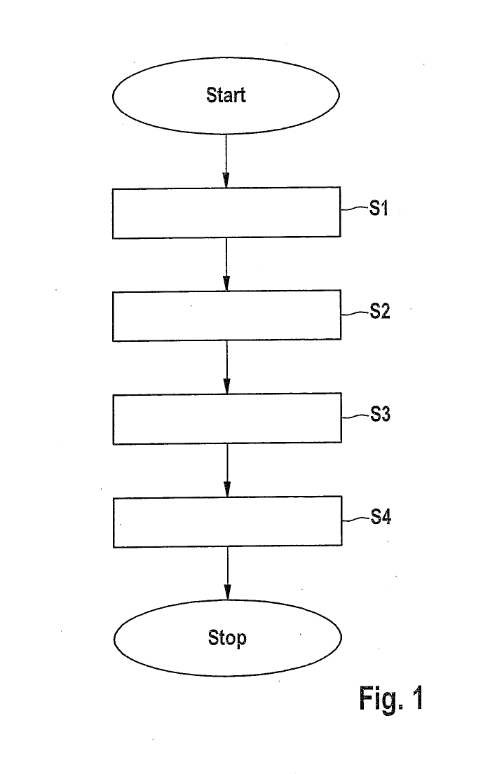

FIG. 1 shows a flow chart to illustrate the method for creating a nonparametric, data-based function model, taking into account certain measuring points through whose assigned output value in each case the function values of the function model to be created essentially pass, i.e., a noteworthy measuring uncertainty is excluded for the certain measuring points.

The use of nonparametric, data-based function models is based on a Bayesian regression method. The Bayesian regression is a data-based method using a model as the basis. Measuring points of training data as well as associated output data of an output variable are required to create the model. The model is created by using node data which entirely or partially correspond to the training data or which are generated from these. Moreover, abstract hyperparameters are determined, which parameterize the space of the model functions and effectively weight the influence of the individual measuring points of the training data on the later model prediction.

The abstract hyperparameters are determined by an optimization method. One option for such an optimization method is an optimization of a marginal likelihood p(Y|H,X). The marginal likelihood p(Y|H,X) describes the plausibility of the measured y values of the training data, represented as vector Y, given model parameters H and the x values of the training data. In the model training, p(Y|H,X) is maximized by finding suitable hyperparameters with which the data may be described particularly well. To simplify the calculation, the logarithm of p(Y|H,X) is maximized since the logarithm does not change the continuity of the plausibility function.

The optimization method automatically ensures a trade-off between model complexity and mapping accuracy of the model. While an arbitrarily high mapping accuracy of the training data is achievable with rising model complexity, this may result in overfitting of the model to the training data at the same time, and thus in a worse generalization property.

The result of the creation of the nonparametric, data-based function model that is obtained is:

$$v = {\sum }_{i = 1}^{N} ( {Q}_{y} ) {σ}_{f} exp ( - \frac{1}{2} {\sum }_{d = 1}^{D} \frac{( {( {x}_{i} )}_{d} - {u}_{d} )}{{I}_{d}} ) ,$$

where v corresponds to the standardized model value at a standardized test point u, xᵢ corresponds to a measuring point of the training data, N corresponds to the number of measuring points of the training data, D corresponds to the dimension of the input data/training data space, and I_{d} and σ_{f} correspond to the hyperparameters from the model training. Q_{y} is a variable calculated from the hyperparameters and the measuring data.

The following applies in an alternative notation:

v=f(u)=k(u,X)(K+σₙ²I)⁻¹Y
or

v=f(u)=k(u,X)(K+R)⁻¹Y,
where X represents a matrix of the measuring points of the input data, Y represents a vector of the output data for the measuring points, K represents a covariance matrix of the measuring points X of the training data, I represents an identity matrix, R represents a diagonal matrix having N entries, and the matrix values R_{i,i} of the diagonal matrix represent the noise variance at the ith measuring point xᵢ of the training data. Moreover, k(u,X) corresponds to a covariance function with respect to the test point u having all training points X.

The hyperparameters of the Gaussian process model are ascertained in the known manner, a specification regarding the noise variance matrix R having to be additionally predefined.

The method starts with step S1 where training data in the form of measuring points X and corresponding output values of output variable Y to be modeled are provided. The training data may be ascertained with the aid of a test bench, for example.

In step S2, a user establishes one or multiple of the measuring points of the training data as certain measuring points through which the curve of the function defined by the function model passes exactly or with only a minor deviation. As an alternative or in addition, further measuring points having correspondingly assigned output values, which represent certain measuring points, may be added to the measuring points of the training data. The certain measuring points thus become part of the training data.

According to the formula above, the measuring points are provided in identity matrix I, which takes into account variance σₙ² for covariance matrix K, for a standard Gaussian process. It is known that the identity matrix has the value 1 only on its diagonal, the remaining values corresponding to 0.

To achieve that the curve of the function defined by the function model passes exactly through at least one output value assigned to a certain measuring point, a variance of zero must be provided for the at least one certain measuring point (step S3). The values of the diagonal matrix which are assigned to the certain measuring points are therefore also set to zero or approximately zero, which means that no, or compared to the remaining measuring points only a very low, variance or measuring uncertainty is predefined for the certain measuring points in question.

The following applies:

v=f(u)=k(u,X)(K+σₙ²M(X,Y)⁻¹Y
where, for example,

$$M ( X , Y ) = [ \begin{matrix}1 & 0 & 0 & 0 & 0 & … & 0 \\ 0 & 0 & 0 & 0 & 0 & … & 0 \\ 0 & 0 & 1 & 0 & 0 & … & 0 \\ 0 & 0 & 0 & 1 & 0 & … & 0 \\ 0 & 0 & 0 & 0 & 1 & … & 0 \\ ⋮ & ⋮ & ⋮ & ⋮ & ⋮ & ⋱ & 0 \\ 0 & 0 & 0 & 0 & 0 & … & 1\end{matrix} ]$$

the second measuring point being provided as a certain measuring point, for example.

Proceeding from these modified training data, in step S4 now hyperparameters σ_{f}, σₙ and I_{d} of the data-based function model are ascertained. In addition to the determination of the hyperparameters, all or some of the training data may be used as node data or node data may be generated from the training data. The hyperparameters and the node data are then transmitted to a control unit, which carries out the calculation of the data-based function model. The node data should include the certain measuring points.

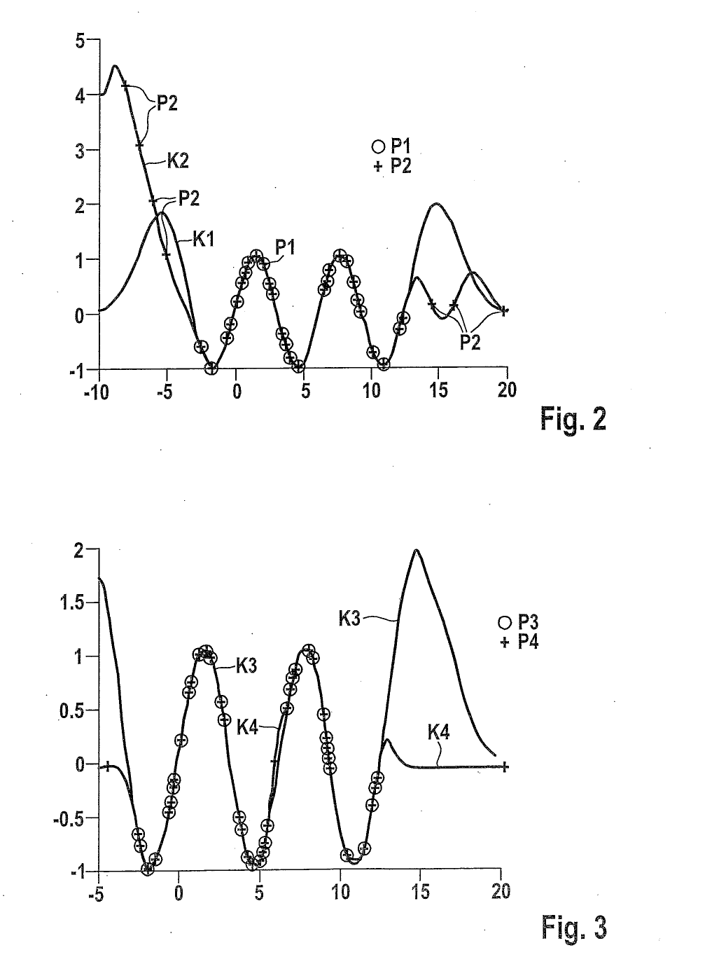

FIG. 2 shows a first example of a test function for an input variable X and an output variable Y (curve K1), which was created as a data-based function model on the basis of predefined measuring points P1 of training data. After the predefinition of certain measuring points P2, whose measuring uncertainty was established at 0, and the creation of the corresponding data-based function model, curve K2 is obtained. It is apparent that curve K2 passes exactly through certain measuring points P2. It is also apparent that the curves of the function model may thus be better formed, in particular at the edges of the input variable area of measuring points P1.

Another example is shown in FIG. 3. Curve K3 represents the function curve of the data-based function model which was created based on predefined measuring points P1 of training data, prior to taking the certain measuring points into account. After predefinition of certain measuring points P4, whose measuring uncertainty was established at 0, and the creation of the corresponding data-based function model, curve K4 is obtained. It is apparent that curve K4 passes exactly through certain measuring points P4. It is further apparent that the function curve of the function model was locally adapted in the area of the input values of the input variables between 6 and 8 as a result of the predefinition of certain measuring point P4 at input value 6 of the input variable of the measuring point.

What is claimed is:

1. A method for ascertaining a nonparametric, data-based function model, the method comprising:
selecting one or multiple ones of the measuring points as certain measuring points or adding one or multiple ones of additional measuring points to provided training data as certain measuring points, wherein the nonparametric, data-based function model is ascertained using the provided training data, the training data including a number of measuring points which are defined by one or multiple input variables and which each have assigned output values of at least one output variable;
assigning a measuring uncertainty value of essentially zero to the certain measuring points; and
ascertaining the nonparametric, data-based function model according to an algorithm which is dependent on the certain measuring points of the modified training data and the measuring uncertainty values assigned in each case.

2. The method of claim 1, wherein measuring uncertainty values, in particular having the level of a variance of the provided training data, are assigned to the measuring points which do not form part of the certain measuring points.

3. The method of claim 1, wherein the nonparametric, data-based function model is defined with the aid of a covariance matrix, a diagonal matrix being applied to the covariance matrix, the diagonal matrix values of which are assigned to the certain measuring points of the training data having a value of essentially zero.

4. The method of claim 1, wherein the nonparametric, data-based function model is ascertained as a Gaussian process model or as a sparse Gaussian process model.

5. The method of claim 1, wherein the nonparametric, data-based function model includes a Gaussian process model.

6. A device, having an arithmetic unit, comprising:
an arrangement configured for ascertaining a nonparametric, data-based function model having provided training data, the training data including a number of measuring points which are defined by one or multiple input variables and which each have assigned output values of at least one output variable, including:
a selecting arrangement to select one or multiple ones of the measuring points as certain measuring points or add one or multiple ones of additional measuring points to the training data as certain measuring points to obtain modified training data;
an assigning arrangement to assign a measuring uncertainty value of essentially zero to the certain measuring points; and
an ascertaining arrangement to ascertain the nonparametric, data-based function model according to an algorithm which is dependent on the certain measuring points of the training data and the measuring uncertainty values assigned in each case.

7. The device of claim 1, wherein the nonparametric, data-based function model includes a Gaussian process model.

8. A computer readable medium having a computer program, which is executable by a processor, comprising:
a program code arrangement having program code for ascertaining a nonparametric, data-based function model, by performing the following:
selecting one or multiple ones of the measuring points as certain measuring points or adding one or multiple ones of additional measuring points to provided training data as certain measuring points, wherein the nonparametric, data-based function model is ascertained using the provided training data, the training data including a number of measuring points which are defined by one or multiple input variables and which each have assigned output values of at least one output variable;
assigning a measuring uncertainty value of essentially zero to the certain measuring points; and
ascertaining the nonparametric, data-based function model according to an algorithm which is dependent on the certain measuring points of the modified training data and the measuring uncertainty values assigned in each case.

9. The method of claim 8, wherein the nonparametric, data-based function model includes a Gaussian process model.

10. An electronic control unit, comprising:
an electronic memory medium having a computer program, which is executable by a processor, including a program code arrangement having program code for ascertaining a nonparametric, data-based function model, by performing the following:
selecting one or multiple ones of the measuring points as certain measuring points or adding one or multiple ones of additional measuring points to provided training data as certain measuring points, wherein the nonparametric, data-based function model is ascertained using the provided training data, the training data including a number of measuring points which are defined by one or multiple input variables and which each have assigned output values of at least one output variable;
assigning a measuring uncertainty value of essentially zero to the certain measuring points; and
ascertaining the nonparametric, data-based function model according to an algorithm which is dependent on the certain measuring points of the modified training data and the measuring uncertainty values assigned in each case.

11. The electronic control unit of claim 10, wherein measuring uncertainty values, in particular having the level of a variance of the provided training data, are assigned to the measuring points which do not form part of the certain measuring points.

12. The electronic control unit of claim 10, wherein the nonparametric, data-based function model is defined with the aid of a covariance matrix, a diagonal matrix being applied to the covariance matrix, the diagonal matrix values of which are assigned to the certain measuring points of the training data having a value of essentially zero.

13. The electronic control unit of claim 10, wherein the nonparametric, data-based function model is ascertained as a Gaussian process model or as a sparse Gaussian process model.

14. The electronic control unit of claim 10, wherein the nonparametric, data-based function model includes a Gaussian process model.
